(19) United States
(12) Patent Application Publication
(10) Pub. No.: US 2021/0092415 A1
(43) Pub. Date: Mar. 25, 2021

(54) IMAGE DATA ENCODING AND DECODING

(71) Applicant: SONY CORPORATION, Tokyo (JP)

(72) Inventors: Stephen Mark KEATING, Reading (GB); Karl James SHARMAN, East Ilsley (GB); Adrian Richard BROWNE, Southampton (GB)

(73) Assignee: SONY CORPORATION, Tokyo (JP)

(21) Appl. No.: 16/579,356

(22) Filed: Sep. 23, 2019

(51) Int. Cl. H04N 19/196; H04N 19/136; H04N 19/11; H04N 19/13; H04N 19/18; H04N 19/124

(52) U.S. Cl. CPC H04N 19/196; H04N 19/136; H04N 19/124; H04N 19/13; H04N 19/18; H04N 19/11

(57) ABSTRACT

Image data encoding apparatus comprises detector circuitry configured to detect at least one of an upper clipping level and a lower clipping level in samples of input image data; and encoder circuitry configured to encode an encoded representation of the samples of input image data to an encoded data stream, the encoder circuitry being configured to encode a representation of the at least one of the upper clipping level and the lower clipping level to the output data stream.

### BACKGROUND

### Field

This disclosure relates to image data encoding and decoding.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, is neither expressly or impliedly admitted as prior art against the present disclosure.

There are several video data encoding and decoding systems which involve transforming video data into a frequency domain representation, quantising the frequency domain coefficients and then applying some form of entropy encoding to the quantised coefficients. This can achieve compression of the video data. A corresponding decoding or decompression technique is applied to recover a reconstructed version of the original video data.

High Efficiency Video Coding (HEVC), also known as H.265 or MPEG-H Part 2, is a proposed successor to H.264/MPEG-4 AVC. It is intended for HEVC to improve video quality and double the data compression ratio compared to H.264, and for it to be scalable from 128×96 to 7680×4320 pixels resolution, roughly equivalent to bit rates ranging from 128 kbit/s to 800 Mbit/s.

### SUMMARY

The present disclosure addresses or mitigates problems arising from this processing.

The present disclosure provides image data encoding apparatus, comprising:

detector circuitry configured to detect at least one of an upper clipping level and a lower clipping level in samples of input image data; and

encoder circuitry configured to encode an encoded representation of the samples of input image data to an encoded data stream, the encoder being configured to encode a representation of the at least one of the upper clipping level and the lower clipping level to the output data stream.

The present disclosure provides an image data encoding method comprising:

detecting at least one of an upper clipping level and a lower clipping level in samples of input image data;

encoding an encoded representation of the samples of input image data to an encoded data stream; and

encoding, by circuitry, a representation of the at least one of the upper clipping level and the lower clipping level to the output data stream.

The present disclosure provides image data decoding apparatus, comprising:

detector circuitry configured to detect, from an encoded representation in an input encoded data stream, at least one of an upper clipping level and a lower clipping level;

decoder circuitry configured to decode samples of image data from an encoded representation in the encoded data stream; and

data clipper circuitry configured to apply clipping to the decoded image data samples to generated respective clipped samples, in dependence upon the at least one of the upper clipping level and the lower clipping level.

The present disclosure provides an image data decoding method comprising:

detecting, from an encoded representation in an input encoded data stream, at least one of an upper clipping level and a lower clipping level;

decoding samples of image data from an encoded representation in the encoded data stream; and

applying, by circuitry, clipping to the decoded image data samples to generated respective clipped samples, in dependence upon the at least one of the upper clipping level and the lower clipping level.

The present disclosure provides image data encoding apparatus, comprising:

encoder circuitry configured to generate an output data stream having an encoded representation of samples of input image data, the samples of input image data being arranged as a set of output data units, the set of output data units having a display order;

parameter generator circuitry configured to generate, for each of the output data units, one or more data mapping parameters defining a data mapping operation to be performed at decoding of the encoded representation; and

parameter encoder circuitry configured to encode, to the output data stream, a representation of the one or more data mapping parameters for a subset of some but not all of the output data units.

The present disclosure provides an image data encoding method comprising:

generating an output data stream having an encoded representation of samples of input image data, the samples of input image data being arranged as a set of output data units, the set of output data units having a display order;

generating, for each of the output data units, one or more data mapping parameters defining a data mapping operation to be performed at decoding of the encoded representation; and

encoding, to the output date stream, a representation of the one or more data mapping parameters for a subset of some but not all of the output data units.

The present disclosure provides image data decoding apparatus, comprising:

decoder circuitry configured to decode an input data stream having an encoded representation of samples of image data, the samples of image data being arranged as a set of input data units, the set of input data units having a display order;

a data mapper configured to apply, for each of the output data units, a data mapping operation defined by one or more data mapping parameters;

a parameter decoder configured to decode, from the input data stream, a representation of the one or more data mapping parameters for a subset of some but not all of the input data units; and

a parameter generator configured to generate, for a given input data unit for which the data mapping parameters are not provided by the input data stream, from data mapping parameters associated with one or more other input data units.

The present disclosure provides an image data decoding method comprising:

decoding an input data stream having an encoded representation of samples of image data, the samples of image data being arranged as a set of input data units, the set of input data units having a display order;

applying, for each of the output data units, a data mapping operation defined by one or more data mapping parameters;

decoding, from the input data stream, a representation of the one or more data mapping parameters for a subset of some but not all of the input data units; and

generating, for a given input data unit for which the data mapping parameters are not provided by the input data stream, from data mapping parameters associated with one or more other input data units.

The present disclosure provides a non-transitory computer readable medium including computer program instructions, which when executed by a computer causes the computer to perform any one of the methods defined above.

Further respective aspects and features of the present disclosure are defined in the appended claims.

It is to be understood that both the foregoing general description and the following detailed description are exemplary, but are not restrictive, of the present technology.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an audio/video (A/V) data transmission and reception system using video data compression and decompression;

FIG. 2 schematically illustrates a video display system using video data decompression;

FIG. 3 schematically illustrates an audio/video storage system using video data compression and decompression;

FIG. 4 schematically illustrates a video camera using video data compression;

FIGS. 5 and 6 schematically illustrate storage media;

FIG. 7 provides a schematic overview of a video data compression and decompression apparatus;

FIG. 8 schematically illustrates a predictor;

FIG. 9 schematically illustrates a luminance mapping and inverse mapping function;

FIG. 10 schematically illustrates an example luminance reshaping arrangement;

FIGS. 11 and 12 schematically illustrate respective variations of the apparatus of FIG. 7;

FIG. 13 schematically illustrates a clipping value detector;

FIG. 14 schematically illustrates a part of an encoder;

FIG. 15 schematically illustrates a part of a decoder;

FIG. 16 schematically illustrates a clipping apparatus;

FIGS. 17 and 18 schematically illustrate respective sets of ordered images;

FIG. 19 schematically illustrates a parameter generator; and

FIGS. 20 to 23 are schematic flowcharts illustrating respective methods.

### DESCRIPTION OF THE PREFERRED EMBODIMENTS

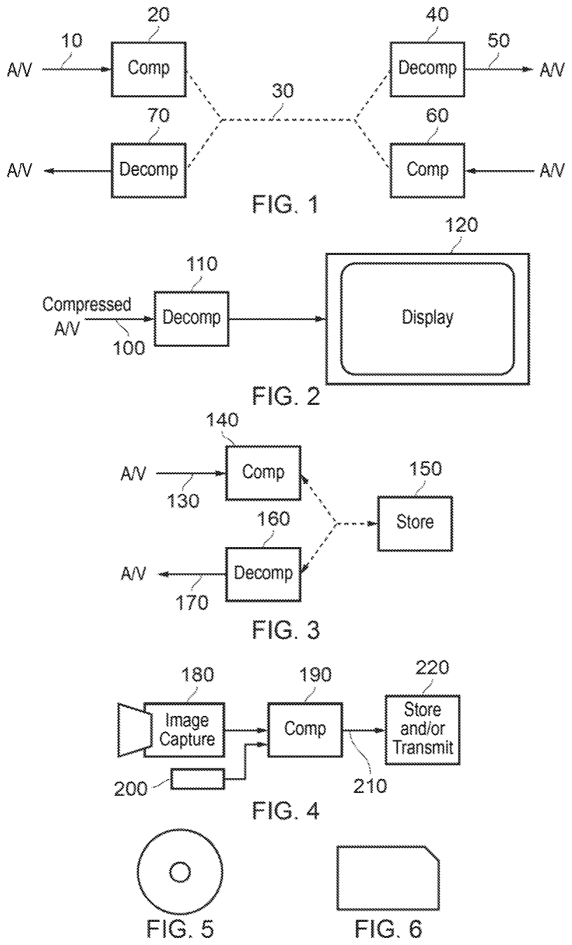

Referring now to the drawings, FIGS. 1-4 are provided to give schematic illustrations of apparatus or systems making use of the compression and/or decompression apparatus to be described below in connection with embodiments of the present technology.

All of the data compression and/or decompression apparatus to be described below may be implemented in hardware, in software running on a general-purpose data processing apparatus such as a general-purpose computer, as programmable hardware such as an application specific integrated circuit (ASIC) or field programmable gate array (FPGA) or as combinations of these. In cases where the embodiments are implemented by software and/or firmware, it will be appreciated that such software and/or firmware, and non-transitory data storage media by which such software and/or firmware are stored or otherwise provided, are considered as embodiments of the present technology.

FIG. 1 schematically illustrates an audio/video data transmission and reception system using video data compression and decompression.

An input audio/video signal 10 is supplied to a video data compression apparatus 20 which compresses at least the video component of the audio/video signal 10 for transmission along a transmission route 30 such as a cable, an optical fibre, a wireless link or the like. The compressed signal is processed by a decompression apparatus 40 to provide an output audio/video signal 50. For the return path, a compression apparatus 60 compresses an audio/video signal for transmission along the transmission route 30 to a decompression apparatus 70.

The compression apparatus 20 and decompression apparatus 70 can therefore form one node of a transmission link. The decompression apparatus 40 and decompression apparatus 60 can form another node of the transmission link. Of course, in instances where the transmission link is uni-directional, only one of the nodes would require a compression apparatus and the other node would only require a decompression apparatus.

FIG. 2 schematically illustrates a video display system using video data decompression. In particular, a compressed audio/video signal 100 is processed by a decompression apparatus 110 to provide a decompressed signal which can be displayed on a display 120. The decompression apparatus 110 could be implemented as an integral part of the display 120, for example being provided within the same casing as the display device. Alternatively, the decompression apparatus 110 maybe provided as (for example) a so-called set top box (STB), noting that the expression “set-top” does not imply a requirement for the box to be sited in any particular orientation or position with respect to the display 120; it is simply a term used in the art to indicate a device which is connectable to a display as a peripheral device.

FIG. 3 schematically illustrates an audio/video storage system using video data compression and decompression. An input audio/video signal 130 is supplied to a compression apparatus 140 which generates a compressed signal for storing by a store device 150 such as a magnetic disk device, an optical disk device, a magnetic tape device, a solid state storage device such as a semiconductor memory or other storage device. For replay, compressed data is read from the storage device 150 and passed to a decompression apparatus 160 for decompression to provide an output audio/video signal 170.

It will be appreciated that the compressed or encoded signal, and a storage medium such as a machine-readable non-transitory storage medium, storing that signal, are considered as embodiments of the present technology.

FIG. 4 schematically illustrates a video camera using video data compression. In FIG. 4, an image capture device 180, such as a charge coupled device (CCD) image sensor and associated control and read-out electronics, generates a video signal which is passed to a compression apparatus 190. A microphone (or plural microphones) 200 generates an audio signal to be passed to the compression apparatus 190. The compression apparatus 190 generates a compressed audio/video signal 210 to be stored and/or transmitted (shown generically as a schematic stage 220).

The techniques to be described below relate primarily to video data compression and decompression. It will be appreciated that many existing techniques may be used for audio data compression in conjunction with the video data compression techniques which will be described, to generate a compressed audio/video signal. Accordingly, a separate discussion of audio data compression will not be provided. It will also be appreciated that the data rate associated with video data, in particular broadcast quality video data, is generally very much higher than the data rate associated with audio data (whether compressed or uncompressed). It will therefore be appreciated that uncompressed audio data could accompany compressed video data to form a compressed audio/video signal. It will further be appreciated that although the present examples (shown in FIGS. 1-4) relate to audio/video data, the techniques to be described below can find use in a system which simply deals with (that is to say, compresses, decompresses, stores, displays and/or transmits) video data. That is to say, the embodiments can apply to video data compression without necessarily having any associated audio data handling at all.

FIG. 4 therefore provides an example of a video capture apparatus comprising an image sensor and an encoding apparatus of the type to be discussed below. FIG. 2 therefore provides an example of a decoding apparatus of the type to be discussed below and a display to which the decoded images are output.

A combination of FIGS. 2 and 4 may provide a video capture apparatus comprising an image sensor 180 and encoding apparatus 190, decoding apparatus 110 and a display 120 to which the decoded images are output.

FIGS. 5 and 6 schematically illustrate storage media, which store (for example) the compressed data generated by the apparatus 20, 60, the compressed data input to the apparatus 110 or the storage media or stages 150, 220. FIG. 5 schematically illustrates a disc storage medium such as a magnetic or optical disc, and FIG. 6 schematically illustrates a solid state storage medium such as a flash memory. Note that FIGS. 5 and 6 can also provide examples of non-transitory machine-readable storage media which store computer software which, when executed by a computer, causes the computer to carry out one or more of the methods to be discussed below.

Therefore, the above arrangements provide examples of video storage, capture, transmission or reception apparatuses embodying any of the present techniques.

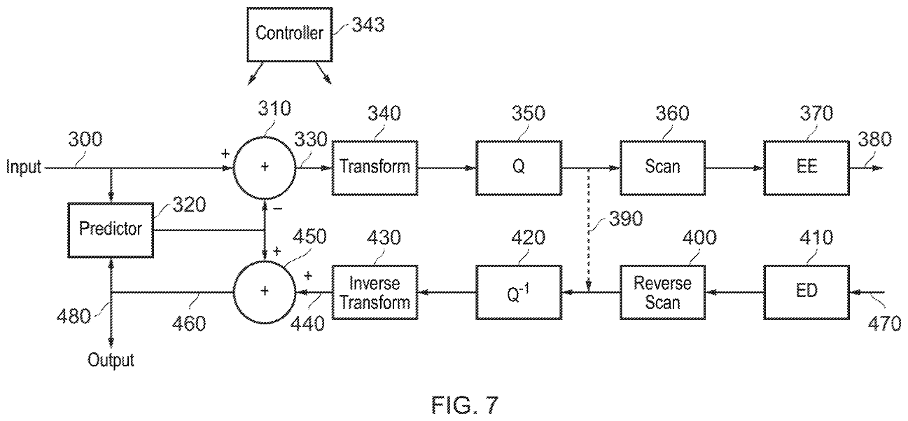

FIG. 7 provides a schematic overview of a video data compression and decompression apparatus.

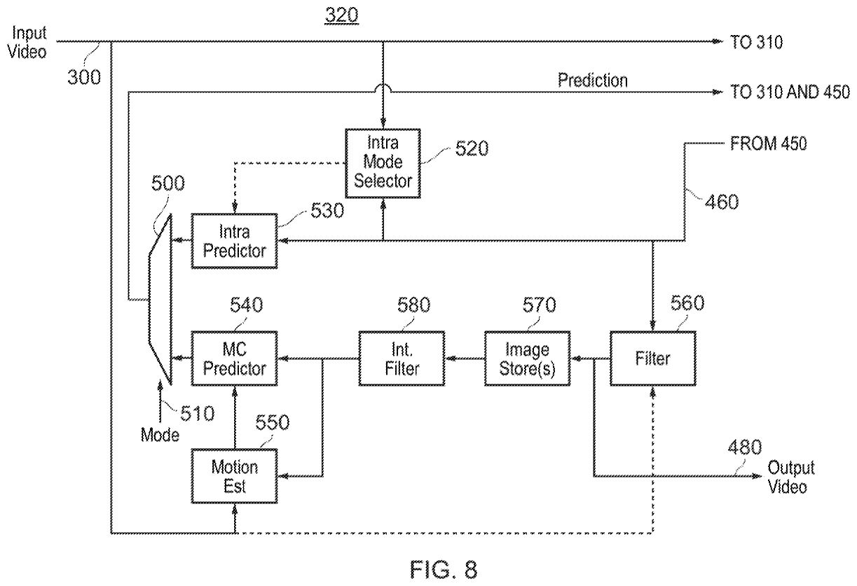

A controller 343 controls the overall operation of the apparatus and, in particular when referring to a compression mode, controls a trial encoding processes by acting as a selector to select various modes of operation such as block sizes and shapes, and whether the video data is to be encoded losslessly or otherwise. The controller is considered to part of the image encoder or image decoder (as the case may be). Successive images of an input video signal 300 are supplied to an adder 310 and to an image predictor 320. The image predictor 320 will be described below in more detail with reference to FIG. 8. The image encoder or decoder (as the case may be) plus the intra-image predictor of FIG. 8 may use features from the apparatus of FIG. 7. This does not mean that the image encoder or decoder necessarily requires every feature of FIG. 7 however.

The adder 310 in fact performs a subtraction (negative addition) operation, in that it receives the input video signal 300 on a “+” input and the output of the image predictor 320 on a “−” input, so that the predicted image is subtracted from the input image. The result is to generate a so-called residual image signal 330 representing the difference between the actual and projected images.

One reason why a residual image signal is generated is as follows. The data coding techniques to be described, that is to say the techniques which will be applied to the residual image signal, tend to work more efficiently when there is less “energy” in the image to be encoded. Here, the term “efficiently” refers to the generation of a small amount of encoded data; for a particular image quality level, it is desirable (and considered “efficient”) to generate as little data as is practicably possible. The reference to “energy” in the residual image relates to the amount of information contained in the residual image. If the predicted image were to be identical to the real image, the difference between the two (that is to say, the residual image) would contain zero information (zero energy) and would be very easy to encode into a small amount of encoded data. In general, if the prediction process can be made to work reasonably well such that the predicted image content is similar to the image content to be encoded, the expectation is that the residual image data will contain less information (less energy) than the input image and so will be easier to encode into a small amount of encoded data.

The remainder of the apparatus acting as an encoder (to encode the residual or difference image) will now be described. The residual image data 330 is supplied to a transform unit or circuitry 340 which generates a discrete cosine transform (DCT) representation of blocks or regions of the residual image data. The DCT technique itself is well known and will not be described in detail here. Note also that the use of DCT is only illustrative of one example arrangement. Other transforms which might be used include, for example, the discrete sine transform (DST). A transform could also comprise a sequence or cascade of individual transforms, such as an arrangement in which one transform is followed (whether directly or not) by another transform. The choice of transform may be determined explicitly and/or be dependent upon side information used to configure the encoder and decoder.

The output of the transform unit 340, which is to say, a set of DCT coefficients for each transformed block of image data, is supplied to a quantiser 350. Various quantisation techniques are known in the field of video data compression, ranging from a simple multiplication by a quantisation scaling factor through to the application of complicated lookup tables under the control of a quantisation parameter. The general aim is twofold. Firstly, the quantisation process reduces the number of possible values of the transformed data. Secondly, the quantisation process can increase the likelihood that values of the transformed data are zero. Both of these can make the entropy encoding process, to be described below, work more efficiently in generating small amounts of compressed video data.

A data scanning process is applied by a scan unit 360. The purpose of the scanning process is to reorder the quantised transformed data so as to gather as many as possible of the non-zero quantised transformed coefficients together, and of course therefore to gather as many as possible of the zero-valued coefficients together. These features can allow so-called run-length coding or similar techniques to be applied efficiently. So, the scanning process involves selecting coefficients from the quantised transformed data, and in particular from a block of coefficients corresponding to a block of image data which has been transformed and quantised, according to a “scanning order” so that (a) all of the coefficients are selected once as part of the scan, and (b) the scan tends to provide the desired reordering. One example scanning order which can tend to give useful results is a so-called up-right diagonal scanning order.

The scanned coefficients are then passed to an entropy encoder (EE) 370. Again, various types of entropy encoding may be used. Two examples are variants of the so-called CABAC (Context Adaptive Binary Arithmetic Coding) system and variants of the so-called CAVLC (Context Adaptive Variable-Length Coding) system. In general terms, CABAC is considered to provide a better efficiency, and in some studies has been shown to provide a 10-20% reduction in the quantity of encoded output data for a comparable image quality compared to CAVLC. However, CAVLC is considered to represent a much lower level of complexity (in terms of its implementation) than CABAC. Note that the scanning process and the entropy encoding process are shown as separate processes, but in fact can be combined or treated together. That is to say, the reading of data into the entropy encoder can take place in the scan order. Corresponding considerations apply to the respective inverse processes to be described below.

The output of the entropy encoder 370, along with additional data (mentioned above and/or discussed below), for example defining the manner in which the predictor 320 generated the predicted image, provides a compressed output video signal 380.

However, a return path is also provided because the operation of the predictor 320 itself depends upon a decompressed version of the compressed output data.

The reason for this feature is as follows. At the appropriate stage in the decompression process (to be described below) a decompressed version of the residual data is generated. This decompressed residual data has to be added to a predicted image to generate an output image (because the original residual data was the difference between the input image and a predicted image). In order that this process is comparable, as between the compression side and the decompression side, the predicted images generated by the predictor 320 should be the same during the compression process and during the decompression process. Of course, at decompression, the apparatus does not have access to the original input images, but only to the decompressed images. Therefore, at compression, the predictor 320 bases its prediction (at least, for inter-image encoding) on decompressed versions of the compressed images.

The entropy encoding process carried out by the entropy encoder 370 is considered (in at least some examples) to be “lossless”, which is to say that it can be reversed to arrive at exactly the same data which was first supplied to the entropy encoder 370. So, in such examples the return path can be implemented before the entropy encoding stage. Indeed, the scanning process carried out by the scan unit 360 is also considered lossless, but in the present embodiment the return path 390 is from the output of the quantiser 350 to the input of a complimentary inverse quantiser 420. In instances where loss or potential loss is introduced by a stage, that stage may be included in the feedback loop formed by the return path. For example, the entropy encoding stage can at least in principle be made lossy, for example by techniques in which bits are encoded within parity information. In such an instance, the entropy encoding and decoding should form part of the feedback loop.

In general terms, an entropy decoder 410, the reverse scan unit 400, an inverse quantiser 420 and an inverse transform unit or circuitry 430 provide the respective inverse functions of the entropy encoder 370, the scan unit 360, the quantiser 350 and the transform unit 340. For now, the discussion will continue through the compression process; the process to decompress an input compressed video signal will be discussed separately below.

In the compression process, the scanned coefficients are passed by the return path 390 from the quantiser 350 to the inverse quantiser 420 which carries out the inverse operation of the scan unit 360. An inverse quantisation and inverse transformation process are carried out by the units 420, 430 to generate a compressed-decompressed residual image signal 440.

The image signal 440 is added, at an adder 450, to the output of the predictor 320 to generate a reconstructed output image 460. This forms one input to the image predictor 320, as will be described below.

Turning now to the process applied to decompress a received compressed video signal 470, the signal is supplied to the entropy decoder 410 and from there to the chain of the reverse scan unit 400, the inverse quantiser 420 and the inverse transform unit 430 before being added to the output of the image predictor 320 by the adder 450. So, at the decoder side, the decoder reconstructs a version of the residual image and then applies this (by the adder 450) to the predicted version of the image (on a block by block basis) so as to decode each block. In straightforward terms, the output 460 of the adder 450 forms the output decompressed video signal 480. In practice, further filtering may optionally be applied (for example, by a filter 560 shown in FIG. 8 but omitted from FIG. 7 for clarity of the higher level diagram of FIG. 7) before the signal is output.

The apparatus of FIGS. 7 and 8 can act as a compression (encoding) apparatus or a decompression (decoding) apparatus. The functions of the two types of apparatus substantially overlap. The scan unit 360 and entropy encoder 370 are not used in a decompression mode, and the operation of the predictor 320 (which will be described in detail below) and other units follow mode and parameter information contained in the received compressed bit-stream rather than generating such information themselves.

FIG. 8 schematically illustrates the generation of predicted images, and in particular the operation of the image predictor 320.

There are two basic modes of prediction carried out by the image predictor 320: so-called intra-image prediction and so-called inter-image, or motion-compensated (MC), prediction. At the encoder side, each involves detecting a prediction direction in respect of a current block to be predicted, and generating a predicted block of samples according to other samples (in the same (intra) or another (inter) image). By virtue of the units 310 or 450, the difference between the predicted block and the actual block is encoded or applied so as to encode or decode the block respectively.

(At the decoder, or at the reverse decoding side of the encoder, the detection of a prediction direction may be in response to data associated with the encoded data by the encoder, indicating which direction was used at the encoder. Or the detection may be in response to the same factors as those on which the decision was made at the encoder).

Intra-image prediction bases a prediction of the content of a block or region of the image on data from within the same image. This corresponds to so-called I-frame encoding in other video compression techniques. In contrast to I-frame encoding, however, which involves encoding the whole image by intra-encoding, in the present embodiments the choice between intra- and inter-encoding can be made on a block-by-block basis, though in other embodiments the choice is still made on an image-by-image basis.

Motion-compensated prediction is an example of inter-image prediction and makes use of motion information which attempts to define the source, in another adjacent or nearby image, of image detail to be encoded in the current image. Accordingly, in an ideal example, the contents of a block of image data in the predicted image can be encoded very simply as a reference (a motion vector) pointing to a corresponding block at the same or a slightly different position in an adjacent image.

A technique known as “block copy” prediction is in some respects a hybrid of the two, as it uses a vector to indicate a block of samples at a position displaced from the currently predicted block within the same image, which should be copied to form the currently predicted block.

Returning to FIG. 8, two image prediction arrangements (corresponding to intra- and inter-image prediction) are shown, the results of which are selected by a multiplexer 500 under the control of a mode signal 510 (for example, from the controller 343) so as to provide blocks of the predicted image for supply to the adders 310 and 450. The choice is made in dependence upon which selection gives the lowest “energy” (which, as discussed above, may be considered as information content requiring encoding), and the choice is signalled to the decoder within the encoded output data-stream. Image energy, in this context, can be detected, for example, by carrying out a trial subtraction of an area of the two versions of the predicted image from the input image, squaring each pixel value of the difference image, summing the squared values, and identifying which of the two versions gives rise to the lower mean squared value of the difference image relating to that image area. In other examples, a trial encoding can be carried out for each selection or potential selection, with a choice then being made according to the cost of each potential selection in terms of one or both of the number of bits required for encoding and distortion to the picture.

The actual prediction, in the intra-encoding system, is made on the basis of image blocks received as part of the signal 460, which is to say, the prediction is based upon encoded-decoded image blocks in order that exactly the same prediction can be made at a decompression apparatus. However, data can be derived from the input video signal 300 by an intra-mode selector 520 to control the operation of the intra-image predictor 530.

For inter-image prediction, a motion compensated (MC) predictor 540 uses motion information such as motion vectors derived by a motion estimator 550 from the input video signal 300. Those motion vectors are applied to a processed version of the reconstructed image 460 by the motion compensated predictor 540 to generate blocks of the inter-image prediction.

Accordingly, the units 530 and 540 (operating with the estimator 550) each act as detectors to detect a prediction direction in respect of a current block to be predicted, and as a generator to generate a predicted block of samples (forming part of the prediction passed to the units 310 and 450) according to other samples defined by the prediction direction.

The processing applied to the signal 460 will now be described. Firstly, the signal is optionally filtered by a filter unit 560, which will be described in greater detail below. This involves applying a “deblocking” filter to remove or at least tend to reduce the effects of the block-based processing carried out by the transform unit 340 and subsequent operations. A sample adaptive offsetting (SAO) filter may also be used. Also, an adaptive loop filter is optionally applied using coefficients derived by processing the reconstructed signal 460 and the input video signal 300. The adaptive loop filter is a type of filter which, using known techniques, applies adaptive filter coefficients to the data to be filtered. That is to say, the filter coefficients can vary in dependence upon various factors. Data defining which filter coefficients to use is included as part of the encoded output data-stream.

The filtered output from the filter unit 560 in fact forms the output video signal 480 when the apparatus is operating as a decompression apparatus. It is also buffered in one or more image or frame stores 570; the storage of successive images is a requirement of motion compensated prediction processing, and in particular the generation of motion vectors. To save on storage requirements, the stored images in the image stores 570 may be held in a compressed form and then decompressed for use in generating motion vectors. For this particular purpose, any known compression/decompression system may be used. The stored images are passed to an interpolation filter 580 which generates a higher resolution version of the stored images; in this example, intermediate samples (sub-samples) are generated such that the resolution of the interpolated image is output by the interpolation filter 580 is 4 times (in each dimension) that of the images stored in the image stores 570 for the luminance channel of 4:2:0 and 8 times (in each dimension) that of the images stored in the image stores 570 for the chrominance channels of 4:2:0. The interpolated images are passed as an input to the motion estimator 550 and also to the motion compensated predictor 540.

The way in which an image is partitioned for compression processing will now be described. At a basic level, an image to be compressed is considered as an array of blocks or regions of samples. The splitting of an image into such blocks or regions can be carried out by a decision tree, such as that described in Bross et al: “High Efficiency Video Coding (HEVC) text specification draft 6”. JCTVC-H1003_d0 (February 2012), the contents of which are incorporated herein by reference. In some examples, the resulting blocks or regions have sizes and, in some cases, shapes which, by virtue of the decision tree, can generally follow the disposition of image features within the image. This in itself can allow for an improved encoding efficiency because samples representing or following similar image features would tend to be grouped together by such an arrangement. In some examples, square blocks or regions of different sizes (such as 4×4 samples up to, say, 64×64 or larger blocks) are available for selection. In other example arrangements, blocks or regions of different shapes such as rectangular blocks (for example, vertically or horizontally oriented) can be used. Other non-square and non-rectangular blocks are envisaged. The result of the division of the image into such blocks or regions is (in at least the present examples) that each sample of an image is allocated to one, and only one, such block or region.

The intra-prediction process will now be discussed. In general terms, intra-prediction involves generating a prediction of a current block of samples from previously-encoded and decoded samples in the same image.

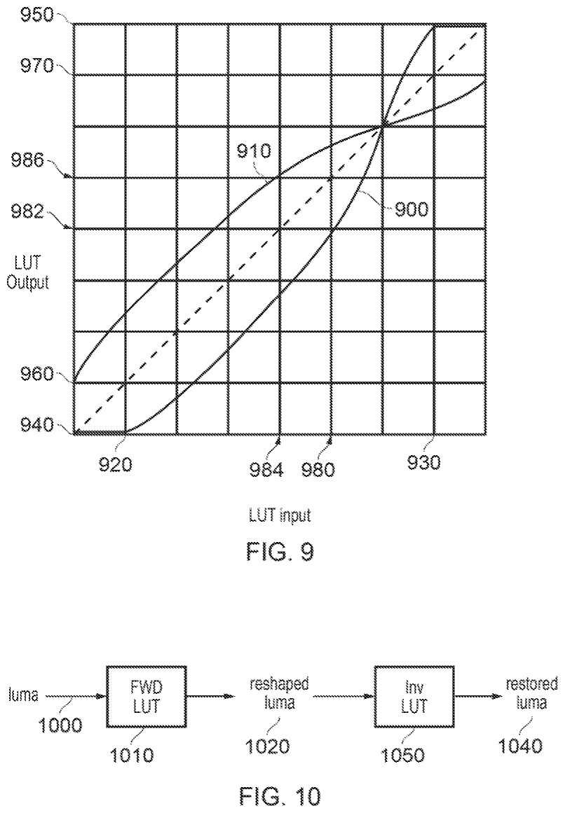

FIG. 9 schematically illustrates a luminance mapping and inverse mapping function. This arrangement can be used in connection with so-called luminance reshaping, for example in a so-called LMCS or luma mapping (with) chroma scaling mode of operation.

The underlying principle of luminance reshaping is to provide an effective variation of the bit depth of the luminance signal at a pixel level. By increasing the effective bit depth for pixels considered to be of a higher importance, pixel detail can be better preserved for those pixels. The notion of “importance” is defined in this context as relating to the pixel value in terms of luminance or within a luminance range.

With reference to FIG. 10, which schematically illustrates an example luminance reshaping arrangement, an input luminance signal 1000 is reshaped by applying a look up table (LUT) 1010 in a forward direction to generate reshaped luminance 1020. This can be reverted to restored luminance 1040 by applying an inverse LUT 1030. So, the process is in principle reversible, except that in some circumstances applying one or both of the LUTs can lead to the effect of clipping the luminance signal, for example by setting the luminance signal to either a minimum possible value or a maximum possible value, such that pixel values which have been clipped cannot be regenerated by applying the inverse LUT.

As an example of the reversible nature of the mapping, consider a luminance sample value 980 (approximately 0.75 of the full range as drawn, or about 768 in a ten bit system) as an input to the forward LUT. This is mapped by the curve 900 to a value 982 of about 0.5 in the reshaped luma domain. At the inverse mapping, the same quantity (0.5) is represented by a position 984 on the horizontal axis, which is mapped by the curve 910 to a value 986 of 0.75 in the restored luma.

Note that it is not necessarily a technical requirement of the use of two LUTs that the mapping (away from clipping regions) is reversible; it would in principle be possible to use non-complementary LUTs. However to do that would lead to a net distortion of the image samples, along the lines of applying a gamma function, which is not the intention of the underlying pre-emphasis and compensation process applied by LMCS. So, in general, complementary LUTs are used by LMCS so that the net effect of the forward LUT followed by the inverse LUT is neutral except for any clipping effect (and possibly a gain difference). In example arrangements of LMCS, the inverse LUT may be formed at the decoder as a function of the forward LUT communicated to it by the encoder.

Returning to FIG. 9, an example 900 is shown of the effect of the forward LUT 1010 along with an example 910 showing the effect of the inverse LUT 1030. The horizontal axis represents the input to a respective LUT (either the forward LUT in the case of the curve 900 or the inverse LUT in the case of the curve 910) and the vertical axis represents the output of the respective LUT.

Regarding the “clipping” aspect mentioned above, it can be seen that for any original luminance values below a threshold 920, the values will be clipped by the forward LUT (curve 900) so that values below the threshold 920 will be clipped to the lowest possible luminance value 940 in the reshaped luminance. When the inverse LUT is applied, any reshaped luminance samples at the luminance value 940 are output at the luminance value 960 which is in fact equal to the value 920 by symmetry. The net effect of the combination of the forward and inverse LUTs in this instance is that any original luminance sample of less than the value 920 is clipped to the value 920.

Similarly, at the high end of the value range, the forward LUT dips any original sample value over a threshold 930 to the highest possible value 950, which is in turn converted back by the inverse LUT curve 910 to the value 970 (equal to the value 930). So once again, the net effect of the combination of the forward and inverse LUTs is that any original luminance sample over the value 930 is clipped to the value 940 and values above the threshold value 930 will be clipped to the highest possible luminance value 950.

The forward LUT 1010 and the inverse LUT 1030 can be expressed as piecewise linear functions having multiple sampling points along the horizontal axis of FIG. 9. For example, 16 sample points along the horizontal axis, equally spaced in the available range of original luminance values, may be used, with each one having an associated point on the vertical axis, so that for any input luminance value x (to either of the LUTs) lying between two of the sample points on the horizontal axis x₁, x₂, the corresponding output luminance value y from that LUT is formed as an interpolation between the LUT values y₁, y₂ respectively corresponding to x₁ and x₂.

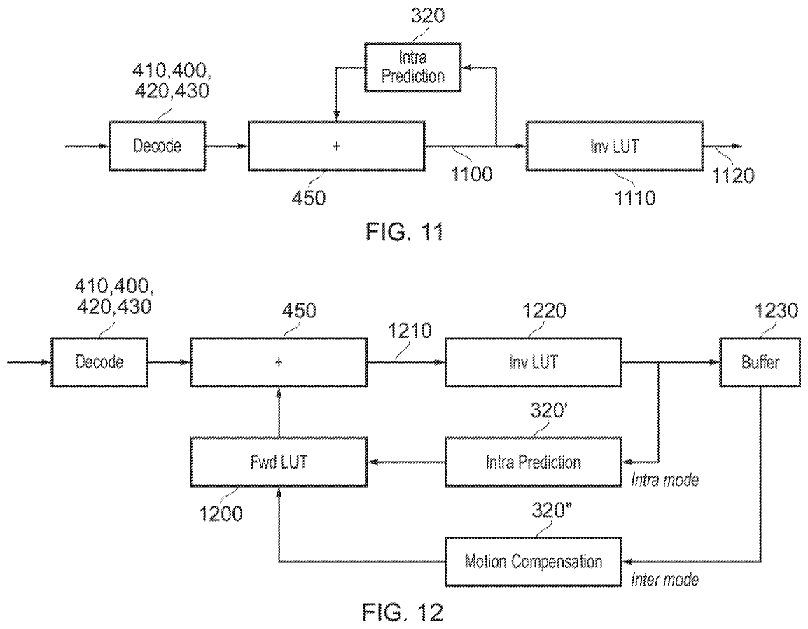

FIGS. 11 and 12 schematically illustrate respective variations of the apparatus of FIG. 7 making use of luminance reshaping. Here, FIG. 11 relates to operations within a so-called intra block and FIG. 12 relates to operations within a so-called inter block.

Comparing FIG. 11 with FIG. 7, the decode path or reverse path operations 400, 410, 420, 430 and the adder 450 are shown, with the predictor 320 being embodied by an intra predictor. The reverse or decode path 400-430 generates residual luminance values which are provided to the adder 450 along with predicted luminance values from the predictor 320 to generate reconstructed luminance values 1100 which are then subjected to the inverse LUT 1110 to generate output samples 1120.

In FIG. 12, within the inter frame, prediction may take place by an intra predictor 320′ or a motion compensated inter predictor 320″. In either case, the predicted samples are processed by the forward LUT 1200, with once again the reconstructed output 1210 of the adder 450 being processed by the inverse LUT 12 and 20 to provide the input to the intra or inter predictors 320′, 320″. A buffer 1230, similar in function to the image store 570 of FIG. 8, may be provided to store samples for use in inter-prediction.

Note that a process of so-called chrome or chrominance scaling may also be carried out in the LMCS system. This can involve multiplying chrominance values by a scaling parameter to generate scaled chrominance values and then undoing the scaling by dividing by the same parameter to generate restored chrominance values. However, this process will not be further described in relation to the present embodiments.

A feature of the LMCS system is that the LUT values need to be signalled between the encoder and the decoder. This signalling can be performed as part of one or more parameter sets but nevertheless can generate a non-trivial overhead in terms of data quantities to be communicated and stored at the encoder and decoder. Example embodiments to be described below address this issue in two different ways, which can be applied individually or together.

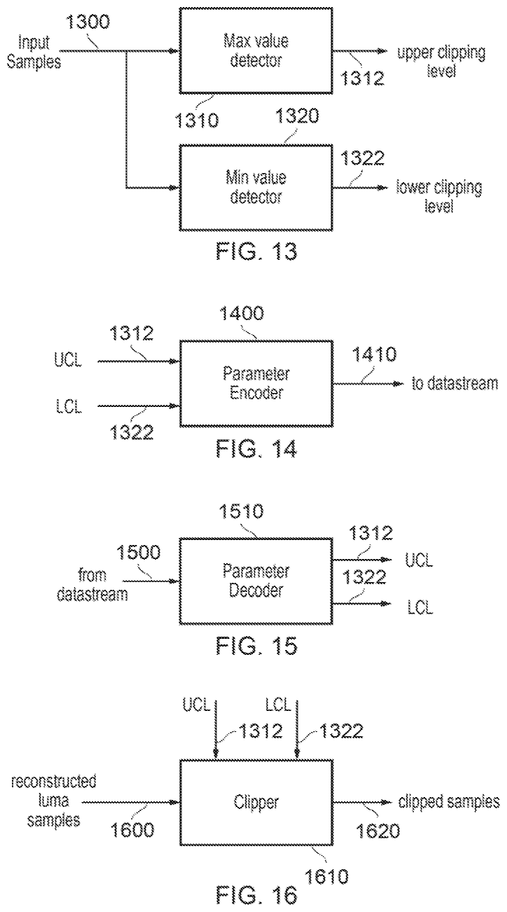

### Clipping Examples—FIGS. 13 to 16

In some example embodiments, instead of a relatively large piecewise linear LUT, a somewhat simpler set of clipping parameters may be provided.

Noting that as described above, the net effect of the application of the forward LUT followed by the inverse LUT can be neutral except for clipping and a gain difference, example embodiments recognise that an elegantly simpler solution can be obtained by applying a clipping function and allowing the routine adjustment of other parameters within the encoding system to handle any need for a gain difference.

FIG. 13 schematically illustrates a clipping value detector as an example of detector circuitry configured to detect at least one of an upper clipping level and a lower clipping level in samples of input image data and in which, for input samples 1300 of a particular image or image portion, a maximum value detector 1310 detects the maximum sample value within that image or image portion, and a minimum value detector 1320 detects the minimum sample value within that image or image portion. If this is performed at the encoder side with respect to image samples to be encoded by the encoder, then the maximum value detected by the detector 1310 can form an upper clipping level (UCL) 1312 to be communicated to the decoder side, because at the decoder side, any reconstructed samples above the upper clipping level are evidently noisy and should therefore be clipped back down to the upper clipping level. Similarly, the minimum value detected by the detector 1320 can form a lower clipping level (LCL) 1322 to be communicated to the decoder side because, once again, any reconstructed samples at the decoder side falling below the lower clipping level 1322 are evidently noisy and should be clipped to the lower clipping level 1322.

Therefore, the clipping operation is defined as follows:
input sample<LCL: clip to LCL as output sample
LCL<=input sample<=UCL: pass unaltered as output sample
Input sample>UCL: dip to UCL as output sample

The single application of this clipping stage to the reconstructed samples (whether or not the resulting clipped reconstructed samples are then used as an input to an intra-image predictor and/or an inter-image predictor) can therefore provide a similar function (in terms of extreme sample values at least) to that of the combination of the forward and inverse LUTs described above, but requiring conveniently more straightforward processing hardware or logic and/or fewer parameters to be generated and/or transmitted.

In the reverse path of the encoder and also at the decoder, the clipping process is applied to the reconstructed data, which is to say the output 460 of the adder 450 of FIG. 7. This is the only place at which the clipping process is applied, whether in the intra block mode described with reference to FIG. 11 above or the inter block mode described with reference to FIG. 12 above. In order for corresponding processes to be carried out at the encoder and the decoder, it is necessary to communicate in some form the upper clipping level 1312 and the lower clipping level 1322 between the encoder site and the decoder side, noting that the values were derived (as discussed with reference to FIG. 13) at the encoder side.

In FIG. 13, the detector circuitry is configured to detect, as the lower clipping level, a lowest sample value amongst the samples of the input image data and to detect, as the upper clipping level, a highest sample value amongst the samples of the input image data.

FIG. 14 schematically illustrates a part of an encoder in which a parameter encoder 1400 (as an example of encoder circuitry configured to encode an encoded representation of the samples of input image data to an encoded data stream, the encoder being configured to encode a representation of the at least one of the upper clipping level and the lower clipping level to the output data stream) receives the upper clipping level 1312 and the lower clipping level 1322 as derived at the encoder side and encodes them to form a part 1410 of the encoded data stream. For example, this can be carried out by encoding the levels 1312, 1322 within a parameter set or by using a feature such as a so-called adaptive parameter set (APS) to refer to previously prepared or referenced values. For example, the levels 1312, 1322 can be derived in respect of respective frames or images and communicated to the decoder on the basis of one instance for each frame or image.

In the examples of FIGS. 13 and 14, the detector circuitry is configured to detect both of the upper clipping level and the lower clipping level; and the encoder circuitry is configured to encode both of the upper clipping level and the lower clipping level to the encoded data stream.

Similarly, FIG. 15 schematically illustrates a part of a decoder (as an example of detector circuitry configured to detect, from an encoded representation in an input encoded data stream, at least one of an upper clipping level and a lower clipping level) in which information 1500 from the data stream is decoded by a parameter decoder 1510 to reconstruct the upper clipping level 1312 and the lower clipping level 1322 for use by the decoder side.

FIG. 16 schematically illustrates a clipping apparatus forming part of an encoder or a decoder in which reconstructed luminance samples 1600 provided to a clipper (such as clipper circuitry) 1610 which is in turn responsive to the upper clipping level 1312 and the lower clipping level 1322 to generate clipped luminance samples 1620. Depending on the arrangement in use (comparing with FIGS. 11 and 12, the clipped samples may form part of the output signal and/or may provide the input to the predictor 320 of FIG. 7. The clipper 1610 is an example of data clipper circuitry configured to apply clipping to the reconstructed image data samples to generated respective clipped samples, in dependence upon the at least one of the upper clipping level and the lower clipping level and acts on data at the output of a decoding circuitry stage 400-430 (as a decoder or in the decode path of an encoder) configured to decode the encoded representation to generate reconstructed image data samples.

The data clipper circuitry 1610 is configured to dip any decoded image data sample having a sample value less than the lower clipping level so that the corresponding clipped sample has a sample value equal to the lower clipping level, and to dip any decoded image data sample having a sample value greater than the upper clipping level so that the corresponding clipped sample has a sample value equal to the upper clipping level.

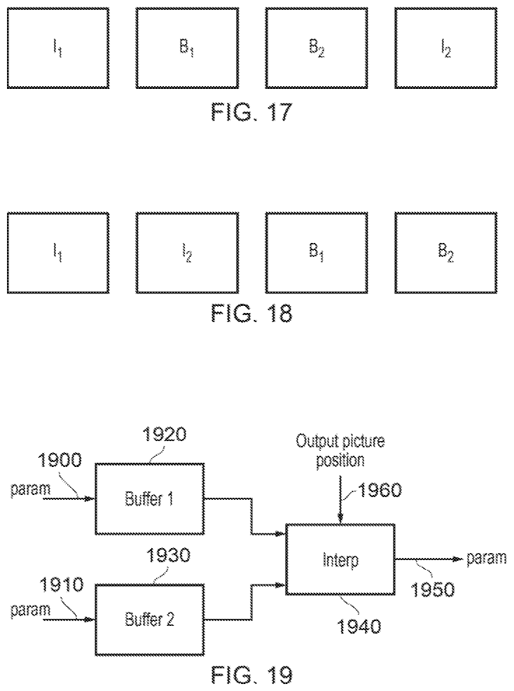

### Parameter Generation Examples—FIGS. 17 to 19

In either the LMCS systems described above or the clipping arrangement described above, there is a need to communicate parameters such as one or more LUTs, or the UCL/LCL, to the decoder. Even though the number of data values (for example, 16 in the case of an LUT or two in the case of the UCL/LCL) can be relatively low, they can still provide a non-trivial data communication overhead in at least some situations. Example embodiments will now be described in which this data communication overhead can be alleviated.

FIGS. 17 and 18 schematically illustrate respective sets of ordered images as examples of output data units such as images or frames, slices and ties having a display order. In the examples shown, a pair of intra-encoded images (I frames) I₁, I₂, are provided along with a pair of bidirectionally-encoded images (B frames)) B₁, B₂, each of which is encoded in dependence upon both of the intra-encoded images. FIG. 17 represents a display order with display time running from left to right as drawn. FIG. 18 represents an example encoding and transmission order in which the intra-encoded images are encoded and transmitted first, followed by the bidirectionally-encoded images so that the image data upon which the bidirectionally-encoded images depends is both generated and provided before encoding or decoding of the bidirectionally encoded images is performed.

In example embodiments, the LMCS or clipping parameters discussed above are generated and transmitted from the encoder side to the decoder side by parameter generation circuitry (such as that of FIG. 13) an parameter encoder circuitry (such as that of FIG. 14), for example in one or more parameter sets, but only in respect of a subset of images. The subset may be, for example, only intra-encoded images (I frames), or only I frames and predicted images (P frames) if present, or only some but not all of the I frames and P frames. In the specific example of FIG. 18, assumed that the relevant parameters are communicated in respect of the I frames but not in respect of the B frames. Therefore, to provide either LMCS parameters or the UCL/LCL parameters for use in respect of the B frames of FIGS. 17 and 18, a process to generate the missing parameters can be carried out.

Where the mapping operation is carried out at the encoder side (for example, though not exclusively, in the decode path of an encoder) the encoder is configured to apply the data mapping operation at generation of the output data stream for an output data unit, in accordance with the data mapping parameters associated with that output data unit.

For example, the process could be a simple re-use of the relevant parameters associated with the temporally nearest image for which such parameters have been communicated, where temporal proximity is with respect to the display order of FIG. 17.

A further alternative arrangement is that amongst the relevant parameters associated with the two temporally nearest images for which such parameters have been communicated, the least onerous could be selected, which is to say the ones which lead to the least amount of clipping. For example, amongst two available sets of (UCL, LCL), that pair which have the greater value of (UCL−LCL) could be selected. Or the selection could take into account the clipping margins: (max level−UCL) and (LCL−lowest level); and not use that one of the sets with the highest individual clipping margin.

In another example, an interpolation process could be used to interpolate parameters for use with a particular frame with reference to parameters associated with temporally surrounding frames, again where the temporal reference is with respect to the display order of FIG. 17.

Where this happens at the encoder side, the encoder is configured to interpolate data mapping parameters for a given output data unit for which the data mapping parameters are not encoded by the parameter encoder, using an interpolation operation dependent on the position in the display order, of the given output data unit with respect to at least one other output data unit for which data mapping parameters are encoded by the parameter encoder. Where this happens at a decoder, the decoder is configured to interpolate data mapping parameters for the given input data unit for which the data mapping parameters are not provided by the input data stream, using an interpolation operation dependent on the position in the display order, of the given input data unit with respect to at least one other input data unit for which data mapping parameters are provided by the input data stream.

FIG. 19 schematically illustrates a parameter generator configured to receive parameters 1900, 1910 associated with, for example, the I frames I₁, I₂ and to buffer the received parameters in respective buffers (or respective portions of a larger buffer) 1920, 1930. The parameter generator outputs a set of parameters for use with each frame. In connection with the interpolation example given above, an interpolator 1940 generates output parameters 1950 for use in connection with a particular image to be processed by an interpolation process dependent upon the output picture or frame's temporal position 1960 in the display order. Note that in the case of the example of FIG. 17, the four images shown may be associated with temporal display positions relative to I₁ (t=0) and I₂ (t=1) as follows:

| frame | factor |
|---|---|
| I₁ | 0.0 |
| B₁ | 0.33 |
| B₂ | 0.66 |
| I₂ | 1.0 |

The interpolated parameters are generated as follows, for each such parameter:

interpolated parameter=(factor*I₂ parameter)+((1−factor)*I₁ parameter)

Note that this arrangement intrinsically provides the correct set of parameters for use with the frames I₁, I₂ themselves.

In connection with the other examples given above, the interpolator functionality could instead be provided by a selector or other arrangement as another example of a parameter generator.

The parameters to be communicated in these examples may comprise for example sample clipping parameters and/or luma mapping with chroma scaling (LMCS) parameters.

Therefore, an example image data decoding apparatus comprises a decoder (400-430 etc.) configured to decode an input data stream having an encoded representation of samples of image data, the samples of image data being arranged as a set of input data units, the set of input data units having a display order; a data mapper 1610 configured to apply, for each of the output data units, a data mapping operation defined by one or more data mapping parameters; a parameter decoder 1510 configured to decode, from the input data stream, a representation of the one or more data mapping parameters for a subset of some but not all of the input data units; and a parameter generator 1940 configured to generate, for a given input data unit for which the data mapping parameters are not provided by the input data stream, from data mapping parameters associated with one or more other input data units.

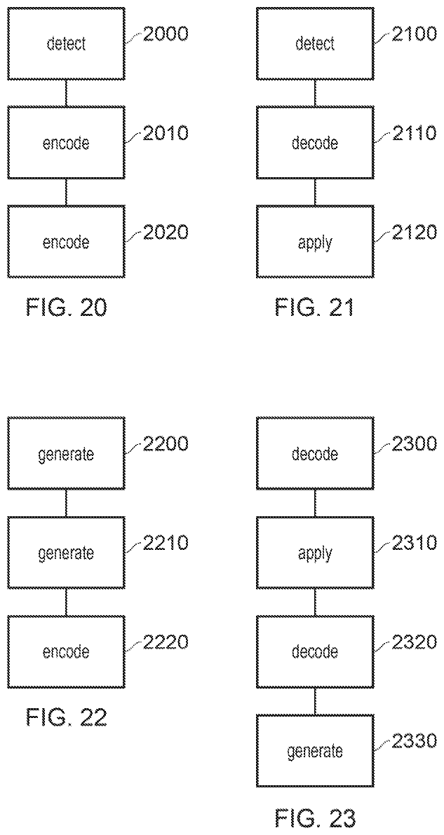

### Example Methods—FIGS. 20-23

FIG. 20 is a schematic flowchart illustrating an image data encoding method which in example embodiments is performed by circuitry, the method comprising:

detecting (at a step 2000) at least one of an upper clipping level and a lower clipping level in samples of input image data;

encoding (at a step 2010) an encoded representation of the samples of input image data to an encoded data stream; and

encoding (at a step 2020) a representation of the at least one of the upper clipping level and the lower clipping level to the output data stream.

FIG. 21 is a schematic flowchart illustrating an image data decoding method which in example embodiments is performed by circuitry, the method comprising:

detecting (at a step 2100), from an encoded representation in an input encoded data stream, at least one of an upper clipping level and a lower clipping level;

decoding (at a step 2110) samples of image data from an encoded representation in the encoded data stream; and

applying (at a step 2120) clipping to the decoded image data samples to generated respective clipped samples, in dependence upon the at least one of the upper clipping level and the lower clipping level.

FIG. 22 is a schematic flowchart illustrating an image data encoding method which in example embodiments is performed by circuitry, the method comprising:

generating (at a step 2200) an output data stream having an encoded representation of samples of input image data, the samples of input image data being arranged as a set of output data units, the set of output data units having a display order;

generating (at a step 2210), for each of the output data units, one or more data mapping parameters defining a data mapping operation to be performed at decoding of the encoded representation; and

encoding (at a step 2220), to the output data stream, a representation of the one or more data mapping parameters for a subset of some but not all of the output data units.

FIG. 23 is a schematic flowchart illustrating an image data decoding method which in example embodiments is performed by circuitry, the method comprising:

decoding (at a step 2300) an input data stream having an encoded representation of samples of image data, the samples of image data being arranged as a set of input data units, the set of input data units having a display order;

applying (at a step 2310), for each of the output data units, a data mapping operation defined by one or more data mapping parameters;

decoding (at a step 2320), from the input data stream, a representation of the one or more data mapping parameters for a subset of some but not all of the input data units; and

generating (at a step 2330), for a given input data unit for which the data mapping parameters are not provided by the input data stream, from data mapping parameters associated with one or more other input data units.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Similarly, a data signal comprising coded data generated according to the methods discussed above (whether or not embodied on a non-transitory machine-readable medium) is also considered to represent an embodiment of the present disclosure.

It will be apparent that numerous modifications and variations of the present disclosure are possible in light of the above teachings. It is therefore to be understood that within the scope of the appended clauses, the technology may be practised otherwise than as specifically described herein.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Respective aspects and features are defined by the following numbered clauses:

1. Image data encoding apparatus, comprising:

detector circuitry configured to detect at least one of an upper clipping level and a lower clipping level in samples of input image data; and

encoder circuitry configured to encode an encoded representation of the samples of input image data to an encoded data stream, the encoder being configured to encode a representation of the at least one of the upper clipping level and the lower clipping level to the output data stream.

2. The apparatus of clause 1, in which:

the detector circuitry is configured to detect both of the upper clipping level and the lower clipping level; and

the encoder circuitry is configured to encode both of the upper clipping level and the lower clipping level to the encoded data stream

3. The apparatus of clause 1 or clause 2, in which the detector circuitry is configured to detect as the lower clipping level, a lowest sample value amongst the samples of the input image data.
4. The apparatus of any one of the preceding clauses, in which the detector circuitry is configured to detect, as the upper clipping level, a highest sample value amongst the samples of the input image data.
5. The apparatus of any one of the preceding clauses, comprising a decoding circuitry stage configured to decode the encoded representation to generate reconstructed image data samples.
6. The apparatus of clause 5, comprising data clipper circuitry configured to apply clipping to the reconstructed image data samples to generated respective clipped samples, in dependence upon the at least one of the upper clipping level and the lower clipping level.
7. The apparatus of clause 6, in which the encoder comprises:

image data predictor circuitry configured to generate predicted image data in dependence upon the clipped samples; and

difference encoder circuitry configured to encode difference data representing a difference between input image data and the predicted image data.

8. Video storage, capture, transmission or reception apparatus comprising the apparatus of any one of the preceding clauses.
9. An image data encoding method comprising:

detecting at least one of an upper clipping level and a lower clipping level in samples of input image data;

encoding an encoded representation of the samples of input image data to an encoded data stream: and

encoding, by circuitry, a representation of the at least one of the upper clipping level and the lower clipping level to the output data stream.

10. A non-transitory computer readable medium including computer program instructions, which when executed by a computer causes the computer to perform the method of clause 9.
11. A data signal comprising coded data generated according to the method of clause 9.
12. Image data decoding apparatus, comprising:

detector circuitry configured to detect, from an encoded representation in an input encoded data stream, at least one of an upper clipping level and a lower clipping level;

decoder circuitry configured to decode samples of image data from an encoded representation in the encoded data stream; and

data clipper circuitry configured to apply clipping to the decoded image data samples to generated respective clipped samples, in dependence upon the at least one of the upper clipping level and the lower clipping level.

13. The apparatus of clause 12, in which the data clipper circuitry is configured to dip any decoded image data sample having a sample value less than the lower clipping level so that the corresponding clipped sample has a sample value equal to the lower clipping level.
14. The apparatus of clause 12 or clause 13, in which the data clipper circuitry is configured to clip any decoded image data sample having a sample value greater than the upper clipping level so that the corresponding clipped sample has a sample value equal to the upper clipping level.
15. The apparatus of any one of clauses 12 to 14, in which the decoder comprises:

image data predictor circuitry configured to generate predicted image data in dependence upon the clipped samples;

difference decoder circuitry configured to decode difference data representing a difference between input image data and the predicted image data; and

combiner circuitry configured to combine the predicted image data and the decoded difference data.

16. An image data decoding method comprising:

detecting, from an encoded representation in an input encoded data stream, at least one of an upper clipping level and a lower clipping level;

decoding samples of image data from an encoded representation in the encoded data stream; and

applying, by circuitry, clipping to the decoded image data samples to generated respective clipped samples, in dependence upon the at least one of the upper clipping level and the lower clipping level.

17. A non-transitory computer readable medium including computer program instructions, which when executed by a computer causes the computer to perform the method of clause 16.
18. Image data encoding apparatus, comprising:

encoder circuitry configured to generate an output data stream having an encoded representation of samples of input image data, the samples of input image data being arranged as a set of output data units, the set of output data units having a display order;

parameter generator circuitry configured to generate, for each of the output data units, one or more data mapping parameters defining a data mapping operation to be performed at decoding of the encoded representation; and

parameter encoder circuitry configured to encode, to the output data stream, a representation of the one or more data mapping parameters for a subset of some but not all of the output data units.

19. The apparatus of clause 18, in which the encoder is configured to apply the data mapping operation at generation of the output data stream for an output data unit, in accordance with the data mapping parameters associated with that output data unit.
20. The apparatus of clause 18 or clause 19, in which the encoder is configured to interpolate data mapping parameters for a given output data unit for which the data mapping parameters are not encoded by the parameter encoder, using an interpolation operation dependent on the position in the display order, of the given output data unit with respect to at least one other output data unit for which data mapping parameters are encoded by the parameter encoder.
21. The apparatus of any one of clauses 18 to 20, in which the output data units comprise one or more of pictures, slices and tiles.
22. The apparatus of any one of clauses 18 to 21, in which the data mapping parameters comprise sample clipping parameters.
23. The apparatus of any one of clauses 18 to 21, in which the data mapping parameters comprise luma mapping with chroma scaling (LMCS) parameters.
24. An image data encoding method comprising:

generating an output data stream having an encoded representation of samples of input image data, the samples of input image data being arranged as a set of output data units, the set of output data units having a display order;

generating, for each of the output data units, one or more data mapping parameters defining a data mapping operation to be performed at decoding of the encoded representation; and

encoding, to the output data stream, a representation of the one or more data mapping parameters for a subset of some but not all of the output data units.

25. A non-transitory computer readable medium including computer program instructions, which when executed by a computer causes the computer to perform the method of clause 24.
26. A data signal comprising coded data generated according to the method of clause 24.
27. Image data decoding apparatus, comprising:

decoder circuitry configured to decode an input data stream having an encoded representation of samples of image data, the samples of image data being arranged as a set of input data units, the set of input data units having a display order;

a data mapper configured to apply, for each of the output data units, a data mapping operation defined by one or more data mapping parameters;

a parameter decoder configured to decode, from the input data stream, a representation of the one or more data mapping parameters for a subset of some but not all of the input data units; and

a parameter generator configured to generate, for a given input data unit for which the data mapping parameters are not provided by the input data stream, from data mapping parameters associated with one or more other input data units.

28. The apparatus of clause 27, in which the decoder circuitry is configured to interpolate data mapping parameters for the given input data unit for which the data mapping parameters are not provided by the input data stream, using an interpolation operation dependent on the position in the display order, of the given input data unit with respect to at least one other input data unit for which data mapping parameters are provided by the input data stream.
29. The apparatus of clause 27 or clause 28, in which the output data units comprise one or more of pictures, slices and tiles.
30. The apparatus of any one of clauses 27 to 29, in which the data mapping parameters comprise sample clipping parameters.
31. The apparatus of any one of clauses 27 to 30, in which the data mapping parameters comprise luma mapping with chroma scaling (LMCS) parameters
32. An image data decoding method comprising:

decoding an input data stream having an encoded representation of samples of image data, the samples of image data being arranged as a set of input data units, the set of input data units having a display order;

applying, for each of the output data units, a data mapping operation defined by one or more data mapping parameters;

decoding, from the input data stream, a representation of the one or more data mapping parameters for a subset of some but not all of the input data units; and

generating, for a given input data unit for which the data mapping parameters are not provided by the input data stream, from data mapping parameters associated with one or more other input data units.

33. A non-transitory computer readable medium including computer program instructions, which when executed by a computer causes the computer to perform the method of clause 32.

We claim:

1. Image data encoding apparatus, comprising:
detector circuitry configured to detect at least one of an upper clipping level and a lower clipping level in samples of input image data; and
encoder circuitry configured to encode an encoded representation of the samples of input image data to an encoded data stream, the encoder circuitry being configured to encode a representation of the at least one of the upper clipping level and the lower clipping level to the output data stream.

2. The apparatus of claim 1, in which:
the detector circuitry is configured to detect both of the upper clipping level and the lower clipping level; and
the encoder circuitry is configured to encode both of the upper clipping level and the lower clipping level to the encoded data stream

3. The apparatus of claim 1, in which the detector circuitry is configured to detect, as the lower clipping level, a lowest sample value amongst the samples of the input image data.

4. The apparatus of claim 1, in which the detector circuitry is configured to detect, as the upper clipping level, a highest sample value amongst the samples of the input image data.

5. The apparatus of claim 1, comprising a decoding circuitry stage configured to decode the encoded representation to generate reconstructed image data samples.

6. The apparatus of claim 5, comprising data clipper circuitry configured to apply clipping to the reconstructed image data samples to generated respective clipped samples, in dependence upon the at least one of the upper clipping level and the lower clipping level.

7. The apparatus of claim 6, in which the encoder circuitry comprises:
Image data predictor circuitry configured to generate predicted image data in dependence upon the clipped samples; and
difference encoder circuitry configured to encode difference data representing a difference between input image data and the predicted image data.

8. Video storage, capture, transmission or reception apparatus comprising the apparatus of claim 1.

9. An image data encoding method comprising:
detecting at least one of an upper clipping level and a lower clipping level in samples of input image data;
encoding an encoded representation of the samples of input image data to an encoded data stream; and
encoding, by circuitry, a representation of the at least one of the upper clipping level and the lower clipping level to the output data stream.

10. A non-transitory computer readable medium including computer program instructions, which when executed by a computer causes the computer to perform the method of claim 9.

11. Image data decoding apparatus, comprising:
detector circuitry configured to detect, from an encoded representation in an input encoded data stream, at least one of an upper clipping level and a lower clipping level;
decoder circuitry configured to decode samples of image data from an encoded representation in the encoded data stream; and
data clipper circuitry configured to apply clipping to the decoded image data samples to generated respective clipped samples, in dependence upon the at least one of the upper clipping level and the lower clipping level.

12. The apparatus of claim 11, in which the data clipper circuitry is configured to dip any decoded image data sample having a sample value less than the lower clipping level so that the corresponding clipped sample has a sample value equal to the lower clipping level.

13. The apparatus of claim 11, in which the data clipper circuitry is configured to dip any decoded image data sample having a sample value greater than the upper clipping level so that the corresponding clipped sample has a sample value equal to the upper clipping level.

14. The apparatus of claim 11, in which the decoder comprises:
image data predictor circuitry configured to generate predicted image data in dependence upon the clipped samples;
difference decoder circuitry configured to decode difference data representing a difference between input image data and the predicted image data; and
combiner circuitry configured to combine the predicted image data and the decoded difference data.

15. An image data decoding method comprising:
detecting, from an encoded representation in an input encoded data stream, at least one of an upper clipping level and a lower clipping level;
decoding samples of image data from an encoded representation in the encoded data stream; and
applying, by circuitry, clipping to the decoded image data samples to generated respective clipped samples, in dependence upon the at least one of the upper clipping level and the lower clipping level.

16. A non-transitory computer readable medium including computer program instructions, which when executed by a computer causes the computer to perform the method of claim 15.

17. Image data encoding apparatus, comprising:
encoder circuitry configured to generate an output data stream having an encoded representation of samples of input image data, the samples of input image data being arranged as a set of output data units, the set of output data units having a display order;
parameter generator circuitry configured to generate, for each of the output data units, one or more data mapping parameters defining a data mapping operation to be performed at decoding of the encoded representation; and
parameter encoder circuitry configured to encode, to the output data stream, a representation of the one or more data mapping parameters for a subset of some but not all of the output data units.

18. The apparatus of claim 17, in which the encoder circuitry is configured to apply the data mapping operation at generation of the output data stream for an output data unit, in accordance with the data mapping parameters associated with that output data unit.

19. The apparatus of claim 17, in which the data mapping parameters comprise sample clipping parameters.

20. The apparatus of claim 17, in which the data mapping parameters comprise luma mapping with chroma scaling (LMCS) parameters.
